(19) United States
(12) Patent Application Publication
(10) Pub. No.: US 2017/0288302 A1
(43) Pub. Date: Oct. 5, 2017

(54) WATER-RIGHT LTE ANTENNA HAVING PU POTTING

(71) Applicant: Hirschmann Car Communication GmbH, Neckartenzlingen (DE)

(72) Inventors: David SILVA, Nuertingen (DE); Rainer SCHIEMANN, Esslingen-Berkheim (DE)

(21) Appl. No.: 15/516,586

(22) PCT Filed: Dec. 17, 2015
(86) PCT No.: PCT/EP2015/080286

§ 371 Date: Jun. 8, 2017

(30) Foreign Application Priority Data
Dec. 18, 2014 (DE) 10 2014 119 059.9

(51) Int. Cl. H01Q 1/32; H01Q 1/40

(52) U.S. Cl. CPC H01Q 1/32; H01Q 1/40

(57) ABSTRACT

The invention relates to an antenna (1) for a vehicle, comprising a carrier, in particular a circuit board (8), wherein antenna structures for transmitting and/or receiving high-frequency signals are arranged on the carrier, and wherein the antenna (1) has a plug connector (5) for connecting to an electronic device, characterized in that the antenna (1) has a plastic half-shell (2) having a peripheral frame (3), into which plastic half-shell the carrier is inserted, wherein the plastic half-shell (2) is filled up with a potting mass (4).

The invention relates to an antenna for a vehicle, having a support, particularly a circuit board, carrying antenna structures for transmitting and/or receiving high-frequency signals and with a plug connector for connecting the antenna to an electronic device according to the features of the preamble of patent claim 1.

Water-tight products are required for antenna applications on the exterior of an automobile. Water-tight housings, for example two housing parts that are interconnected by a gasket, are expensive to manufacture and assemble and are therefore generally very cost-intensive.

It is therefore the object of the invention to further develop a known antenna such that it is simple to manufacture and cost-effective and has the required water-tightness.

This object is achieved by the features of patent claim 1.

According to the invention, the antenna has a plastic half-shell with an annular frame into which the support is inserted, with the plastic half-shell being filled with a potting compound. The plastic half-shell with the annular frame can be manufactured in a cost-effective manner, for example in a plastic injection-molding process. This is particularly true of high lot sizes. After the manufacture of the plastic half-shell with the annular frame, the support—for example, the circuit board carrying the antenna structures for transmitting and/or receiving high-frequency signals—can be fitted into the annular frame of the plastic half-shell and fixed in its required position. The plastic half-shell is then filled with the potting compound until at least the upper face of the support, preferably both faces as well as the edges, are embedded in the potting compound. Since the volume of the plastic half-shell to be filled with the potting compound is known (optionally also that of the support, the fastener, and the plug connector extending into the plastic half-shell), a predetermined amount of potting compound can be filled into the plastic half-shell and harden there, thereby providing the required water-tightness and thus mechanical protection for the sensitive antenna structures as well. The volume of the potting compound is selected such that the potting compound cannot overflow the upper edge of the annular frame, but rather ends right at or slightly below it. After the above-described manufacture of the antenna, the support, particularly the circuit board, with the antenna structures is advantageously not only enclosed completely by potting compound, but rather, due to the presence of the plastic half-shell with the annular frame, the antenna also has the stability that is required for applications mounted outside an automobile.

In a development of the invention, the support, particularly the circuit board, is fastened to the plastic half-shell by a fastener. This fastener can be locking hooks that coact with spacers on the surface of the plastic half-shell in order to fix the laminar support, particularly the circuit board, a short spacing above the surface of the plastic half-shell, so that the space created in this way can be filled with the potting compound in order to achieve water-tightness. As will readily be understood, other types of fastener, such as rivets, screws, or simple spacers that are between the support and the plastic half-shell and are subsequently also embedded in the potting compound are also conceivable. In a development of the invention, the plastic half-shell forms a plug connector housing of the plug connector. This offers the advantage that the plug connector housing of the plug connector is also already manufactured directly during the manufacture of the plastic half-shell, particularly in a plastic casting process or in a plastic injection-molding process. The separate manufacture of a plug connector housing that can be mounted on the plastic half-shell is thus advantageously omitted but is also possible as an alternative nonetheless. In a development of the invention, the plastic half-shell has a mounting base. The mounting base is designed such that it can be used to position and fasten the antenna in the desired installation site.

In addition or as an alternative to the mounting base of the plastic half-shell, it is conceivable for the antenna, particularly the mounting base, to be connected to a holder, particularly an angle bracket. The antenna can be positioned and fixed at its installation site either using only the mounting base or using only the holder or through the joint use of the mounting base and the holder. If the mounting base and the holder are separate components, it is advantageous for a unitary mounting base of the antenna to be used that works with different holders, particularly different angle brackets, thus enabling adaptation to different installation geometries.

In a development of the invention, the mounting base is connected via at least one bar to the holder, particularly the angle bracket. In this way, the antenna can be arranged approximately at a right angle to the mounting surface where it is arranged and fixed, with this arrangement achieving the stability that is required especially in applications outside an automobile through the at least one bar, particularly two bars. In a development of the invention, the plug connector is a FAKRA plug connector. A standardized plug connector is thus made available for automotive use, so that the antenna can be used universally and connected to the electronic device.

In a development of the invention, the potting compound is a PU-based or epoxy-based or silicone-based compound. Different variants are thus available for the potting compound that can be selected as a function of the materials used (particularly the material of the support and of the plastic half-shell), the usage conditions (for example, the interior or exterior of the vehicle), the manageability during pouring, and the cost. It is especially advantageous if the potting compound is a PU (polyurethane) based compound, since such a potting compound makes water-tightness and very good manageability available at relatively low cost.

An embodiment of an antenna according to the invention is described below and explained with reference to the figures in which:

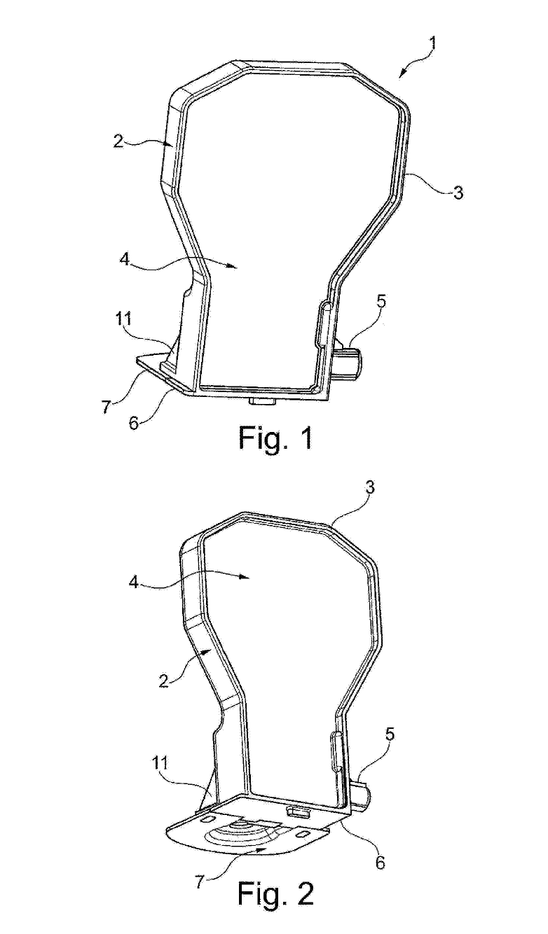

FIGS. 1 to 3 show, insofar as is shown in detail, an antenna 1 having a plastic half-shell 2, with the plastic half-shell 2 having an annular frame 3 particularly on its outer edge.

Depending on the antenna structures, antenna elements, or the like used, the antenna 1 is designed to transmit and/or receive high-frequency signals. The frequency ranges and services (such as telephone, internet, GPS, WLAN, etc.) can be freely selected. The use of LTE (Long-Term Evolution) frequencies is especially advantageous, since the antenna is then used on the exterior of the vehicle where water-tightness plays an important role. In FIGS. 1 to 3, a support (no longer visible) with antenna structures has been placed into the plastic half-shell 2, and the volume within the plastic half-shell 2 has been filled with a potting compound 4 up to no more than the level of the edge of the annular frame 3.

The plastic half-shell 2 is filled with the potting compound 4 up to no higher than the upper edge of the annular frame 3, but it can also be filled to below the frame 3. A plug connector 5, particularly a FAKRA plug connector, projects outward from the antenna 1 in order to feed the signals received by the antenna 1 via a suitable mating plug connector and a cable to an electronic device (not shown in further detail). The same applies when high-frequency signals are to be emitted via an electronic device from the antenna 1.

For the purpose of fastening the antenna 1 in its installation site, it has a mounting base 6 that is formed unitarily of one piece with the plastic half-shell 2, its frame 3, the plug connector 5 (more precisely, its plug connector housing), and the mounting base 6. While the mounting base 6 can be designed such that it can be used to position and fix the antenna 1 at its installation site, in an alternative embodiment an angle bracket 7 is fixed to the mounting base 6. If the angle bracket 7 (or, generally, a another type of holder that need not necessarily be angular) is made of a metallic material and can optionally be used for a ground connection or to shield the antenna 1.

FIG. 4 shows the antenna 1 before the potting compound 4 has been poured into the plastic half-shell 2. It can be seen here that a support, particularly a circuit board 8, has been fitted into the frame 3 of the plastic half-shell 2. It is conceivable for spacers to be present on the surface of the plastic half-shell 2 facing toward the circuit board 8, so that the potting compound 4 can flow through a gap between the outer edge of the circuit board 8 and the inner surface of the frame 3 into the space between the surface of the circuit board 8 and the surface of the plastic half-shell 2. In addition or alternatively to this space, the circuit board 8 can, as shown in FIG. 4, also have at least one hole, particularly also several holes, so that the potting compound 4 can be poured into the laminar space between plastic half-shell 2 and the circuit board 8. This is necessary particularly if the outer edge of the circuit board 8 rests completely or nearly completely against the frame 3 or is position at a very short spacing therefrom. Moreover, FIG. 4 shows that a fastener 9 is present. Here, the fastener 9 is a screw that extends through a hole in the circuit board 8 and engages in a screwthread of the plastic half-shell 2. In this case as well, at least one spacer can be present between the back face of the circuit board 8 directed toward the plastic half-shell 2, and the surface of the plastic half-shell 2 that is directed toward the back face of the circuit board 8 in order to maintain the circuit board 8 at a spacing from the plastic half-shell 2. While the plug connector housing is a component of the plastic half-shell 2, the inner conductor of the plug connector 5 extends toward a soldering point 10 on the circuit board 8. This means that, after the circuit board 8 has been placed into the plastic half-shell 2, the inner conductor of the plug connector 5 is soldered to the point 10 on the circuit board 8 in order to establish an electrical connection between the plug connector 5 and the antenna structures (neither designated nor shown) on the circuit board 8. The region of the soldering point 10 can also be referred to as the base of the antenna 1.

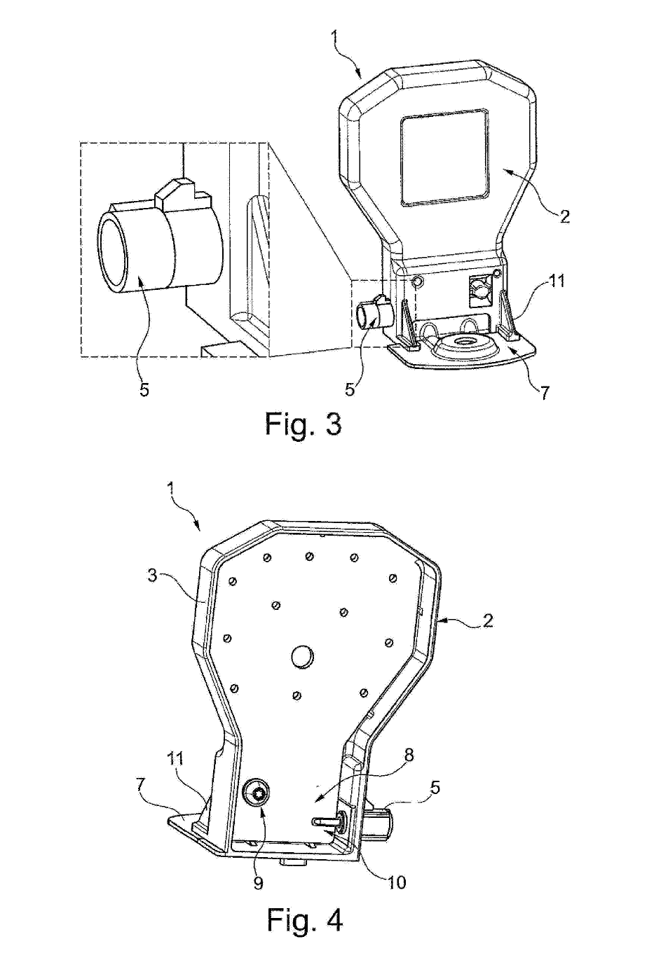

In the embodiment shown, a bar 11 is a component of the plastic half-shell 2. As can be seen very well particularly in FIG. 3, two parallel bars 11 are present that coact with the holder, particularly the angle bracket 7. It is conceivable, for example, for the at least one bar 11 to be embodied such that it can be used to fix the holder, particularly the angle bracket 7, to the plastic half-shell 2. This can be achieved using a tongue-and-groove system between the holder and the bar, so that the holder is pushed up over the at least one bar 11, particularly both bars 11, toward the plastic half-shell 2 and caused to abut, thereby fixing it in place at the same time. This can be durably supported by corresponding locking formations.

While only one single fastener 9 is shown in FIG. 4, it is of course also conceivable to provide more than only one fastener 9.

### List of Reference Symbols

1 Antenna

2 Plastic half-shell

3 Frame

4 Potting compound

5 Plug connector

6 Mounting base

7 Angle bracket

8 Circuit board

9 Fastener

10 Soldering point

11 Bar

1. An antenna for a vehicle, comprising:
a half shell with an annular edge frame forming an upwardly open cavity;
a support in the cavity;
an antenna structure s carried on the support for transmitting and/or receiving high-frequency signals;
a plug connector on the half shell; and
a potting compound generally filling the cavity and surrounding the support and the antenna structure.

2. The antenna defined in claim 1, further comprising:
a fastener fixing the support to the plastic half-shell.

3. The antenna defined in claim 1, wherein the plastic half-shell forms a plug connector housing of the plug connector.

4. The antenna defined in claim 1, wherein the plastic half-shell has a mounting base.

5. The antenna defined in claim 4, wherein the mounting base is connected to an angle bracket.

6. The antenna defined in claim 5, wherein the mounting base is connected by an angle bracket to the holder.

7. The antenna defined in any claim 1, wherein the plug connector is a gFAKRA plug connector.

8. The antenna defined in any claim 1, wherein the potting compound is PU-based.

9. The antenna defined in any one of the preceding claims, wherein the potting compound is epoxy-based.

10. The antenna defined in claim 1, wherein the potting compound is silicone-based.
